(19) United States
(12) Patent Application Publication
(10) Pub. No.: US 2024/0127330 A1
(43) Pub. Date: Apr. 18, 2024

(54) Computer System and Process for Allocating Household Savings Towards Multiple Financial Goals

(71) Applicant: Adrian Becker, Waltham, MA (US)

(72) Inventor: Adrian Becker, Waltham, MA (US)

(21) Appl. No.: 18/479,649

(22) Filed: Oct. 2, 2023

Related U.S. Application Data
(60) Provisional application No. 63/378,236, filed on Oct. 3, 2022.

(51) Int. Cl. G06Q 40/02

(52) U.S. Cl. CPC G06Q 40/02; G06Q 40/06

(57) ABSTRACT

A process was invented which determines how to allocate an individual or household savings budget between multiple future goals by mitigating the risk and/or opportunity cost associated with repurposing such savings at a future date. The process is used to divide a savings budget between multiple goals and retrieve estimated goal funding in a quantitative fashion without resort to qualitative preferences or rules-of-thumb. It is also used to explore potential savings budget amounts and resultant estimated goal funding.

### BACKGROUND OF THE INVENTION

The present disclosure relates generally to a computer system and process. More particularly, the present disclosure relates to a computer system and process for allocating household savings towards multiple financial goals.

Private households and individuals face increasing complexity when planning for goals representing future wants and needs. These households and individuals must shoulder increased decision-risk as they become responsible for more of their financial decisions, as examples:

Employers have gradually shifted from defined benefit retirement plans to defined contribution plans requiring individuals to pick and manage their own investments.¹ ¹ Broadbent, John, Michael Palumbo, and Elizabeth Woodman. “The shift from defined benefit to defined contribution pension plans-implications for asset allocation and risk management.” Reserve Bank of Australia, Board of Governors of the Federal Reserve System and Bank of Canada (2006): 1-54.

Health care coverage options offered by employers and on public exchanges have become more diverse in their coverage, network, pricing, and tax advantages influencing future potential health care costs.^{2,3} ²Barnes, Andrew J., Yaniv Hanoch, and Thomas Rice. “Determinants of Coverage Decisions in Health Insurance Marketplaces: Consumers' Decision-Making Abilities and the Amount of Information in Their Choice Environment.” Health Services Research 50.1 (2015): 58-80.³Wilensky, Gail R. “Asking the right questions about narrow networks: an increasing number of employer plans and many plans being offered through the federal health insurance exchanges use restricted networks of hospitals, and these plans often have limited networks of physicians as well.” Healthcare Financial Management 68.11 (2014): 30-32.

Those saving for self or a dependent's education must balance complex decisions related to student debt, education savings, scholarships, and grants.^{4,5,6} ⁴Despard, Mathieu R., et al. “Student debt and hardship: Evidence from a large sample of low-and moderate-income households.” Children and Youth Services Review 70 (2016): 8-18.⁵Masuo, Diane, and Michael Cheang. “Disconnect between parents values for saving and actual savings behavior: Impact on childrens education and financial decision-making.” Journal of Advances in Humanities and Social Sciences 3.6 (2017): 332-339.⁶ Morris, Michael D. “The impact of grants, tax credit and education savings account on parental contributions to college expenses and the educational attainment of children.” (2003).

Households and individuals consistently struggle to maintain recommended levels of emergency savings and manage debt.^{7,8,9} ⁷Chang, Y. Regina, Sherman D. Hanna, and Jessie X. Fan. “Emergency fund levels: Is household behavior rational?.” Financial Counseling and Planning (1997).⁸Lee, Sunwoo Tessa, and Sherman D. Hanna. “What, Me Worry? Financial Knowledge Overconfidence and the Perception of Emergency Fund Needs.” Journal of Financial Counseling and Planning 33.1 (2022): 140-155.⁹Stavins, Joanna. “Unprepared for financial shocks: Emergency savings and credit card debt.” Contemporary Economic Policy 39.1 (2021): 59-82.

Consumers face complex timing, financing, and affordability decisions for planned discretionary purchases.¹⁰ ¹⁰Harcar, Talha, John E. Spillan, and Orsay Kucukemiroglu. “A multi-national study of family decision-making.” Multinational Business Review (2005).

Financial outcomes are influenced by a staggeringly complex set of factors, including but not limited to the tax code (there are over 150 federal tax forms for individuals published by the IRS¹¹), Social Security elections, benefit elections, inflation assumptions, investment projections, as well as employer and government restrictions and regulations. ¹¹U.S. Department of the Treasury, Internal Revenue Service, “Free File Fillable Forms: Program Limitations and Available Forms, (Washington, DC: 2022), https://www.irs.gov/e-file-providers/free-file-fillable-forms-program-limitations-and-available-forms.

These complexities create a need for households and individuals to decide in advance how to allocate their savings budget across multiple goals in each savings period. Accordingly, much attention has been paid in the personal financial planning, advice, and guidance industry to the complexities of each individual type of goal in approaches such as Goal-Based Financial Planning.¹² This and similar approaches typically balance savings of a limited budget between multiple goals by qualitatively gauging household preference through questionnaires or demographic statistics and/or using rules-of-thumb to dictate preferences.^{13,14,15} ¹²Blanchett, David. “The value of goals-based financial planning.” Journal of financial Planning 28.6 (2015): 42-50.¹³Binswanger, Johannes, and Katherine Grace Carman. “How real people make long-term decisions: The case of retirement preparation.” Journal of Economic Behavior & Organization 81.1 (2012): 39-60.¹⁴Drexler, Alejandro, Greg Fischer, and Antoinette Schoar. “Keeping it simple: Financial literacy and rules of thumb.” American Economic Journal: Applied Economics 6.2 (2014): 1-31.¹⁵Stolz, Richard F. “Withdrawal Rules of Thumb Seductively Simple, Yet with Limitations.” Journal of Financial Planning 22.3 (2009): 22.

However, households and individuals face tangible consequences if any given portion of that allocation is repurposed towards a different goal which may require funds at a different time or be subject to different complexities. This is particularly problematic when budget is limited and unable to cover all projected savings needs, savings must be prioritized. Qualitative approaches and rules-of-thumb fail to empower households to properly mitigate and hedge the risk associated with these opportunity costs. Further, such approaches must overcome the challenges of algorithmic, data, and survey bias as they attempt to replace calculation of concrete possible quantitative financial outcomes with a qualitative measure or historically useful heuristic that may not be appropriate for a particular individual or household.^{16,17} ¹⁶Hajian, Sara, Francesco Bonchi, and Carlos Castillo. “Algorithmic bias: From discrimination discovery to fairness-aware data mining.” Proceedings of the 22nd ACM SIGKDD international conference on knowledge discovery and data mining. 2016.¹⁷Kitchenham, Barbara A., and Shari L. Pfleeger. “Personal opinion surveys.” Guide to advanced empirical software engineering. Springer, London, 2008. 63-92.

In addition to the aforementioned issues, there are still a number of problems in this field. There are also a potentially endless number of solutions to these problems. Therefore, what is needed is a computer system and process for allocating household savings towards multiple financial goals having all of the further described features and advantages.

### SUMMARY OF THE INVENTION

The subject matter of this application may involve, in some cases, interrelated products, alternative solutions to a particular problem, and/or a plurality of different uses of a single system or article. The following is intended to be a brief summary of the invention and is not intended to limit the scope of the invention.

A process that determines how to allocate an individual or household savings budget between multiple future goals by mitigating and hedging the risk and/or opportunity cost associated with repurposing such savings at a future date.

The process of paragraph 13 wherein such risk or opportunity cost is quantified in part or whole as investment risk.

The process of paragraph 13 wherein such risk or opportunity cost is quantified in part or whole as taxation risk.

The process of paragraph 13 wherein such risk or opportunity cost is quantified in part or whole as inflation risk.

The process of paragraph 13 wherein such risk or opportunity cost is quantified in part or whole as regulatory risk or limitation of access.

The process of paragraph 13 wherein such risk or opportunity cost is quantified in part or whole as income risk.

The process of paragraph 13 wherein such process includes asset location decisions dictating the type of account savings are held in.

The process of paragraph 13 wherein such risk and/or opportunity cost associated with the planned allocation of savings budgets in multiple time periods are determined holistically.

The process of paragraph 13 wherein such process includes allocating savings between any of retirement, health care spending, insurance protection, and/or emergency savings.

The process of paragraph 21 wherein such process incorporates employer benefit election.

The process of paragraph 21 wherein such process incorporates government benefit election.

The process of paragraph 21 wherein such process incorporates life insurance.

The process of paragraph 21 wherein such process incorporates disability insurance.

The process of paragraph 21 wherein such process incorporates supplemental insurance.

The process of paragraph 21 wherein such process incorporates health insurance.

The process of paragraph 13 wherein such process is decomposed in a manner which first identifies a preferred planning decision for each goal and then allocates a budget between goals by mitigating and hedging the risk or opportunity cost associated with reallocation at a later date.

The process of paragraph 13 wherein a subset of goals have potential expenses in multiple time periods.

The process of paragraph 13 wherein such existing savings are additionally allocated towards goals.

The process of paragraph 13 wherein a larger budget is allocated incrementally by fixing an allocation of a smaller budget and subsequently allocating increasing budgets until the desired budget is reached.

The process of paragraph 31 wherein such incremental budget allocation is used to aid in the process of discovering a desired overall budget.

A computer system for allocating a budget toward multiple financial goals is also disclosed. In this aspect, the computer system includes a computing device housing a memory and a processor. The memory stores instructions, and the processor is operable to execute the instructions. The computer system also includes a user interface displayed on a monitor. The user interface facilitates user interactions with the computer system. A user input device for receiving inputs is connected to the computing device. A first server contains a database, and the database stores files and information for the computer system. The processor is operable to perform financial planning calculations.

### BRIEF DESCRIPTION OF DRAWINGS

FIG. 1 shows one example of the invention process flow: actual steps corresponding to the working example as well as indicators for additional goals and planning alternatives.

FIG. 2 provides a diagrammatic representation of one embodiment of the computer system for allocating household savings towards multiple financial goals.

FIG. 3 provides a diagrammatic representation of one embodiment of a user interface for the computer system.

FIG. 4 provides a diagrammatic representation of another embodiment of the user interface for the computer system.

### DETAILED DESCRIPTION OF THE INVENTION

The detailed description set forth below in connection with the appended drawings is intended as a description of presently preferred embodiments of the invention and does not represent the only forms in which the present disclosure may be constructed and/or utilized. The description sets forth the functions and/or the sequence of steps for constructing and operating the invention in connection with the illustrated embodiments.

Generally, the present disclosure concerns a computer system and process. Specifically, the computer system and process provides for the allocation of household savings or budget towards multiple financial goals. In one embodiment, the computer system may include a non-transitory computer readable medium having instructions allowing and instructing a central processing unit (“CPU” or “processor”) to carry out the steps required during messaging, as described herein. This non-transitory computer readable medium may be stored within a housing of a computing device, or may be accessible through an electronic communication systems, such as a network. When used herein the term “computing device” means any electronic device having a processor, memory, and a graphical user interface (“GUI”) display, including, but not limited to, a cellular phone, a tablet, a laptop, or a desktop. Also, when used herein the term “network” refers to any system of interconnected electronic devices, such as, a cellular communication network or the Internet. Connections in the network may be wired or wireless.

In most embodiments, the computer system may require users to log in to a computerized and networked platform that prompts users to create a profile, which may include, creating a username and password, and providing the system with other relevant information. The computer system may then be operable to allocate users household savings towards their financial goals through a unique process. In some embodiments, the computer system may not require any initial login or password information for users to access the system.

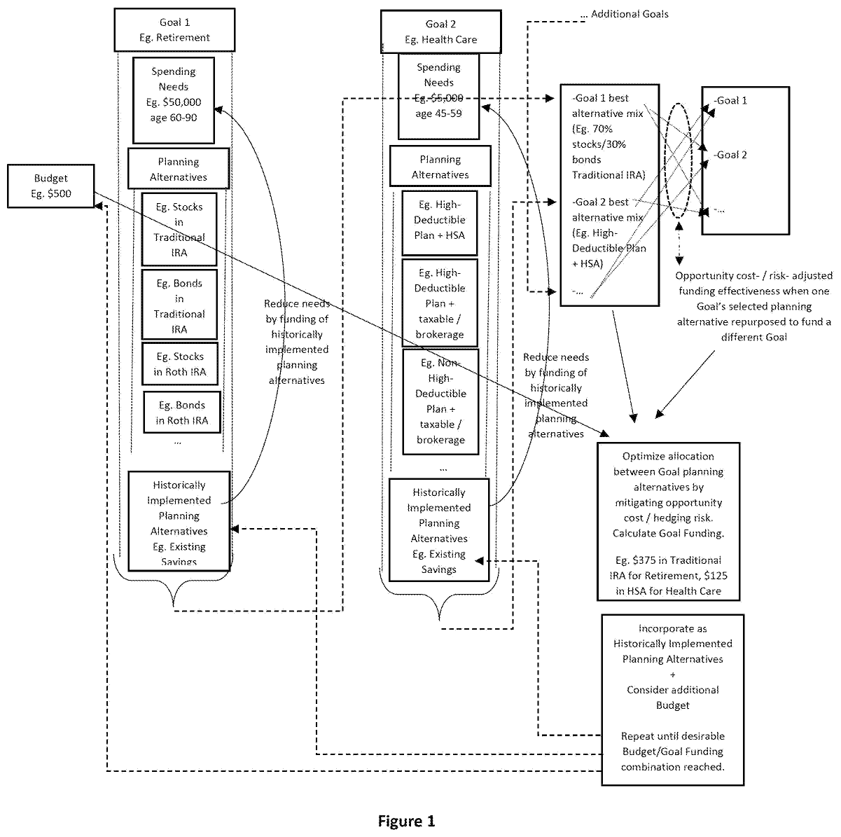

In one embodiment, shown in FIG. 1, the present invention considers (1) a savings budget or portion thereof (referred to herein as B) in one or more savings periods, (2) the set of individual or household goals (referred to herein as G) with associated spending needs in any number of future years, (3) the set of multi-dimensional planning alternatives (referred to herein as Ag) for each goal g∈G including a subset of investment decisions, asset location decisions, insurance coverage decisions, and benefit elections, (4) as well as any historically implemented planning alternatives from prior periods (such as existing savings in particular accounts). It derives the portion of budget to allocate towards each planning alternative (herein referred to as wₐ) for each a∈Ag for each goal g∈G. For example, an individual or household may wish to allocate $500 of its savings budget between health care savings and retirement savings (B=500, G={retirement, healthcare). One dimension for retirement savings may be a choice between saving into a Roth IRA or Traditional IRA to fund retirement needs for spending in multiple future years; whereas another dimension may be the choice of investing in stocks or bonds. In this example we have four planning alternatives: stocks in a Roth IRA, bonds in a Roth IRA, stocks in a Traditional IRA, bonds in a Traditional IRA (Aᵣₑₜᵢᵣₑₘₑₙₜ={Roth/stocks, Roth/bonds, Traditional/stocks, Traditional/bonds}). Continuing this example one dimension of health care savings may be selecting between a High-Deductible/HSA eligible plan and a Non-High-Deductible/HSA ineligible plan; whereas another dimension may be the choice between saving for out-of-pocket expenses in an HSA or taxable savings (or brokerage) account.

In the first step, the invention considers the net goal funding for each goal with respect to each planning alternative (herein referred to as M:G×A→ [symbol] , where A=Πg Ag, and alternatively written as M(g,a) for g∈G, a∈Ag) for a fixed budget consumption by that alternative. Such net goal funding optionally incorporates investment and inflation risk based on the potential timing of goal spending, taxation and regulatory consequences of the action a. If any historically implemented planning alternatives are considered in point 4 of paragraph 46, the spending needs of associated goals are first reduced by the net goal funding of such planning alternatives. Continuing the working example, if stocks are better for longer term investment as opposed to bonds, the difference M(retirement, Roth/stocks)−M(retirement, Roth/bonds) may then increase for planned retirement spending in later years as compared to earlier years. Further, contributing to a Traditional IRA may yield a tax deduction in the savings period whereas contributing a Roth IRA does not, therefore a fixed contribution to a Traditional IRA would consume less of B than the same fixed contribution to a Roth IRA; however when spent, the Traditional IRA may yield deferred taxes in the spending year whereas the Roth IRA may not. M(g,a) incorporates both of these aspects in being the net goal funding per unit of budget consumed. To illustrate, using a $1 unit of budget consumption, if $1 contributed to the Traditional IRA yields a 30% tax deduction in the savings period, risk-adjusted total returns of 50% when invested in stocks before being spent at age 60 and a 20% tax upon withdrawal and spending M(retirement,Traditional/stocks)=$1.·(1+50%)/(1−30%)·(1−20%)=$1.71.

If needed for speed of calculation, in the next step, the invention reduces the dimension of the action space iteratively by deriving an optimal action subspace for each goal. This step is skipped if there is sufficient calculation time is available to proceed otherwise. Continuing the working example, the invention would find the optimal asset allocation for investing in a Traditional IRA (say 70% stocks/30% bonds) and separately find the optimal asset allocation for investing in a Roth IRA (say 80% stocks/20% bonds); the invention is then constrained to consider only allocations with the ratios w_{Traditional/stocks}:w_{Traditional/bonds}=70:30 and w_{Roth/stocks}:w_{Roth/bonds}=80:20 (hereafter referenced to as Aᵣₑₜᵢᵣₑₘₑₙₜ={Traditional, Roth}). Iterating, the invention finds the optimal asset location for each spending year of each goal; to illustrate, if contributing to a Traditional IRA is preferable to a Roth IRA for retirement spending at age 60, the invention is constrained to consider only allocations to a Traditional IRA for such savings.

In the next step, the invention considers the opportunity cost- or risk-adjusted effectiveness when a planning alternative a∈Ag for a particular goal g is later repurposed for a different goal g′ (herein referred to as Eg′,a). Eg′,a is quantified by comparing M(g′,a) to the net goal funding corresponding to the optimal planning alternative for g′ (herein referred to as a_{g}⁺) M(g′, a_{g}⁺). Formulaically

$${a}_{g ′}^{*} = {}_{a ′ ∈ {A}_{g ′}}^{arg max} M ( {g}^{′} , {a}^{′} ) .$$

Such comparison includes consideration of investment and inflation risk given investment timeline, tax treatment, as well as regulatory and access restrictions such as hardship qualification for early 401k withdrawal. Continuing the working example, consider a planning alternative for future health care spending at age 55 that involves saving in an HSA which reduces taxable income in the savings year and may be spent tax-free on qualified health care yielding M(healthcare,hsa)=1.86; if however, that savings is not needed for this projected health care and instead repurposed towards non-health care retirement spending at age 60, the household or individual will incur a 20% tax penalty since they are under age 65. Thus suppose this yields M(retirement,HSA)=1.2. This is compared to the optimal planning alternative for retirement M(retirement,Traditional)=1.71. Likewise, if the optimal Traditional IRA retirement savings in the working example of paragraph 48 is repurposed for health care spending at age 55, they will incur an early withdrawal penalty, deferred taxes on withdrawal, and incur investment risk associated with withdrawing funds early from a longer-term investment; suppose this yields M(healthcare,Traditional)=1.67.

If needed for speed of calculation, Eg′,a is estimated by a function which includes M(g′,a) but excludes M(g′,a_{g}⁺) for different goals g and g′.

In the final step of allocating B, the invention optimizes a composite objective of M(g,a) for all goals g∈G and their associated planning alternatives a∈Ag along with the opportunity cost- or risk-adjusted effectiveness Eg′,a associated with repurposing such planning alternatives towards each other goal g′∈G, such optimization selecting allocations w(g,a) representing fractions of the desired budget amount B, potentially subject to the constraints of paragraph 48. The amounts wₐ·B are then allocated towards each planning alternative. Continuing the working example, one process to optimize in this step is to use the comparison

$${E}_{{g}^{′} , a} = \frac{M ( {g}^{′} , a )}{M ( {g}^{′} , {a}_{gt}^{*} )}$$

in paragraph 49 and the composite objective of maximizing minimum-goal-effectiveness by solving the mathematical optimization problem¹⁸: ¹⁸Bertsimas, Dimitris, and John N. Tsitsiklis. Introduction to linear optimization. Belmont, MA: Athena Scientific, 1997.

$$max γ \qquad ( 1 )$$

$$s . t . γ \leq {\sum }_{g ∈ G} {\sum }_{a ∈ {A}_{g}} {E}_{{g}^{′} , a} \cdot {w}_{a} ∀ {g}^{′} ∈ G \qquad ( 2 )$$

$${\sum }_{g ∈ G} {\sum }_{a ∈ {A}_{g}} {w}_{a} = 1 \qquad ( 3 )$$

$$0 \leq {w}_{a} \leq 1 ∀ a ∈ A \qquad ( 4 )$$

From paragraph 49 in the working example we then have

$${E}_{retirement , Traditional} = 1 , {E}_{healthcare , HSA} = 1 , \\ {E}_{retirement , HSA} = \frac{1.2}{1.71} = 0.7 , {E}_{healthcare , Traditional} = \frac{1.67}{1.86} = 0.9 .$$

Thus, the optimal solution to this problem is w_{HSA}=0.25, w_{Traditional}=0.75. This corresponds to an allocation of 0.25·$500=$125 towards the health care goal in the HSA and 0.75·$500=$375 towards retirement in the Traditional IRA, invested in 70% stocks/30% bonds by paragraph 48.

The expected net goal funding equal to Σ_{a∈A}_{ₛ}M(g,a)·wₐ·B of the derived allocation is added to the net funding of any historically implemented planning alternatives referenced in paragraphs 46 and 47 and the total reported for each goal g. Continuing the working example, retirement goal funding of 1.71·$375=$641 and health care goal funding of 1.86·$125=$233 are reported.

When the complexities of a particular individual or household's situation introduce difficulties (1) in selection of the appropriate amount of fixed budget consumption to use in the calculation of M in paragraph 47 or (2) in the optimization problem solved in paragraph 51, the invention subdivides B into smaller units until such difficulties become manageable. It then fixes the optimal planning alternatives derived from each smaller unit in derivation of the next as-if it where historically implemented, as in paragraph 52. Continuing the working example, suppose the household or individual's current estimated marginal tax bracket (and corresponding deduction rate for Traditional IRA and HSA contributions) is 30%; however suppose that after allocating a combined $100 budget to the Traditional IRA and HSA would lower the estimated tax bracket relevant for further contributions to 25%. In this instance, the invention would first allocate $100 of B in paragraph 51, classify such allocations as historically implemented, and subsequently restart at paragraph 46 allocating the remaining budget of B=$500−$100=$400, recalculating the values of M with the new relevant 25% marginal tax rate.

The invention is extended with an optional additional step allowing for budget exploration in the case that the desired total savings budget B is unknown. An initial starting budget may be selected, and paragraphs 46-53 executed for this initial starting budget. If the resultant reported net goal funding is insufficient and the individual or household desires to save more, the resultant allocations are added to the set of historically implemented planning alternatives and paragraphs 46-53 are repeated. This process is iterated until a desirable budget and net goal funding combination is identified.

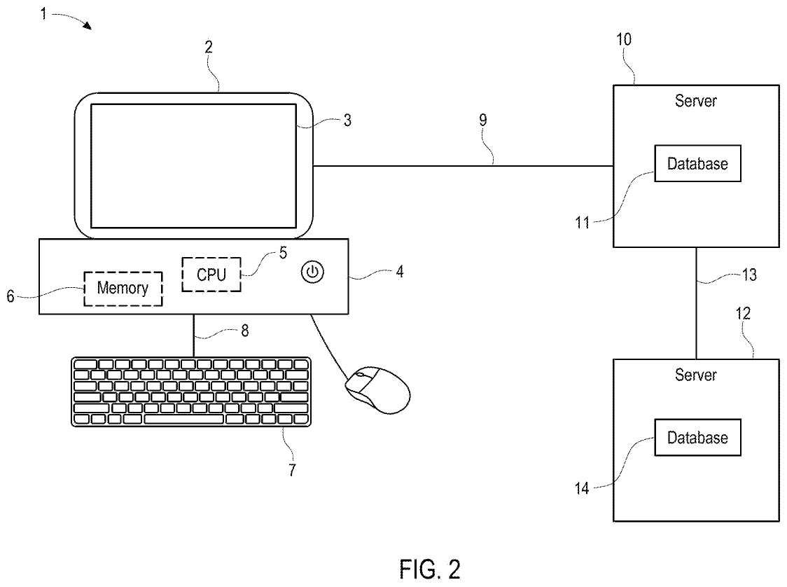

Turning now to FIG. 2, a diagrammatic representation of one embodiment of the computer system 1 is shown. In this embodiment, the computer system comprises several key components, including, but not limited to a monitor 2 and a graphical user interface 3. The monitor 2 facilitates user access to the system 1 by providing a graphical user interface 3 through which users interact with the system. As used herein, the term “monitor” encompasses any electronic display or visual output device capable of presenting graphical or textual information to a user. Such monitors may include, but are not limited to, desktop computer monitors, laptop screens, tablet displays, mobile phone screens, and any other portable or fixed electronic screens or displays designed for human interaction and information presentation.

The computer system 1 also includes a computing device 4, which serves as the core processing unit. The computing device 4 comprises essential components, including, but not limited to, a central processing unit or processor 5 and a memory 6. The central processing unit 5 is responsible for executing various instructions and performing computational tasks. The memory 6 stores instructions and data that are essential for the operation of the computer system. These stored instructions are executed by the processor 5 during system operation.

Similar to the term “monitor,” as used herein, the term “computing device” encompasses any electronic device or apparatus with the capability to process data, execute instructions, and perform computational tasks. Such computing devices may include, but are not limited to, desktop computers, laptops, tablet computers, mobile phones, servers, embedded systems, wearable devices, and any other electronic systems or hardware configured for information processing, storage, and communication.

To facilitate user interaction with the computer system 1, user input devices 7 are provided. In the embodiment shown in FIG. 2, these devices 7 include a mouse and a keyboard, but the term “input device” is meant to encompass any hardware or components designed to facilitate user interaction and input with a computing device, including, but not limited to, touchscreens. The input devices 7 are connected to the computing device 4 through electronic communication lines 8. These communication lines can be either short-range wireless connections, such as a Bluetooth® connection, or hard-wired connections.

As previously described, the computer system 1 includes a computing device 4 and a monitor 2. In this context, the computing device 4 is configured to cause the monitor 2 to display a website or application that embodies the system for allocating household savings towards multiple financial goals on the user interface 3. This user interface 3 provides users with a platform to interact with and utilize the financial planning system.

To enable communication and data transfer between the computing device 4 and the monitor 2, an electronic communication line 9 is established. This line 9 may encompass both wired and wireless connections, including connections to computerized device networks, such as the Internet, cellular networks, and the like. The electronic communication line 9 connects the computing device 4 to a first server 10 specifically designed to support the functionality of the system for allocating household savings towards multiple financial goals. This first server 10 contains a database 11 that stores the necessary files and information required for the operation of the website or application embodying the financial planning system. Such files and information may include historical data, statistical models, user preferences, and any other relevant information. This information may also be stored, entirely or in part, on the memory 6 of the computing device 4.

In addition to the first server 10, the system also includes a second server 12 connected to the first server 10 via an electronic communication line 13. Similar to the first server 10, the second server 12 also contains a database 14 for the storage of files and information. However, unlike the database 11 on the first server 10, the database 14 on the second server 12 may not contain information or files necessary for operation of the system for allocating household savings towards multiple financial goals, but may instead contain information and files for the operation of a third-party service or application.

The electronic communication line 13 allows the first server 10 and the second server 12 to communicate through an application programming interface (“API”), which is operable to both send a request from the first server 10 and receive a response from the second server 12. The request and response communication facilitated by the API enables the system for allocating household savings towards multiple financial goals to receive information from third-party websites or applications and display said information on a user interface.

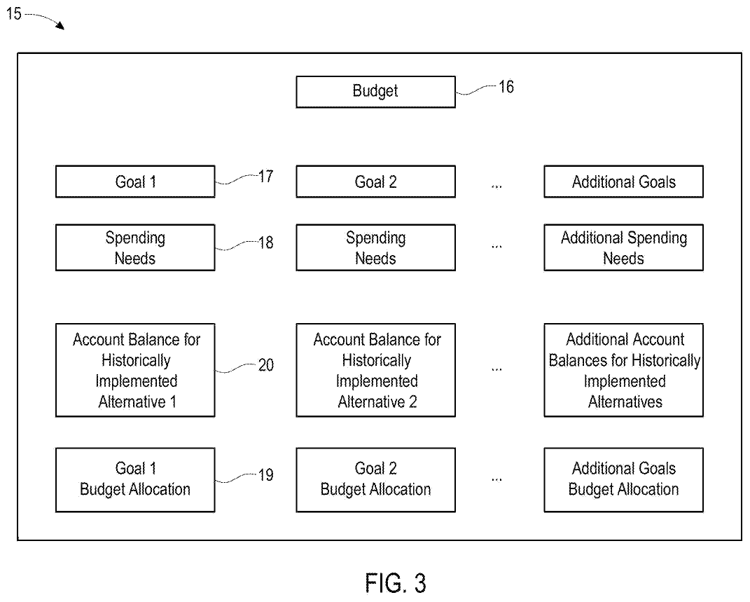

FIG. 3 provides a diagrammatic representation of one embodiment of the information that may be displayed on a user interface 15 of the system for allocating household savings towards multiple financial goals. In this embodiment, the user interface 15 displays a savings budget 16 and one or more financial or future goals 17 after receiving inputs from an input device. Similarly, the user interface 15 also displays one or more spending needs 18 associated with the one or more goals 17 in response to user inputs. Once the budget 16, future goals 17, and spending needs 18 are input, the system is operable to perform calculations in accordance with the process described in reference to FIG. 1, which determines one or more budget allocations 19 corresponding to one or more of the goals 17. The system is then operable to display the one or more budget allocations 19.

The user interface 15 also displays an account balance for a historically implemented planning alternative 20. In most instances, the account balance for the historically implemented planning alternative 20 will be located on a third-party service or application with the information or files being stored in a database of a second server. In one embodiment, a user may input the account balance for the historically implemented planning alternative 20 into the system via an input device. However, in order for the user to determine the account balance for the historically implemented planning alternative 20, the user would have to navigate to a separate user interface displaying the account balance, which may cause the user to lose focus on the specific budget and/or financial planning task they were working on.

The immediately foregoing example presents a technical problem specific to the field of computer systems that is solved by the present disclosure. The technical problem that is being referred to is the limited availability of display space on user interfaces. The limited display space requires users to navigate between interfaces of various websites and/or applications to determine the information they need, which can be cumbersome and distracting. The present disclosure solves this problem by creating a hybrid user interface that simultaneously displays both the account balance for the historically implemented planning alternative 20 and the user interface 15 for the system of allocating household savings towards multiple financial goals.

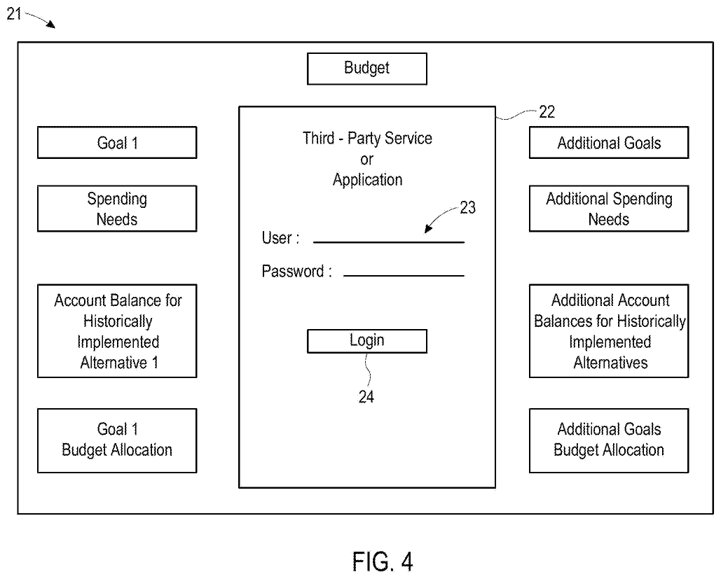

FIG. 4 provides a diagrammatic representation of one embodiment of such a hybrid user interface 21. In this embodiment, the account balance for the historically implemented planning alternative 20 is stored in a database of a second server corresponding to a third-party service or application. The third-party service or application 22 is simultaneously displayed on the user interface 15 of FIG. 3, creating the hybrid user interface 21. The system is operable to create the hybrid user interface 21 by communicating with the second server through an API.

In one embodiment, the API may be operable to send a request for information to the second server after the computer system receives an input selecting the portion of the user interface corresponding to the account balance for the historically implemented planning alternative 20. After receiving a response from the second server through the API, the computer system is then operable to display the third-party service or application 22 on the hybrid user interface 21. The third-party service of application 22 may prompt the user to input credentials 23, such as a username and password, before allowing the user to login 24. Once logged into the third-party service or application 22 the account balance for the historically implemented planning alternative 20 will then be displayed on the hybrid user interface 21.

While the financial planning system and process described herein offers a comprehensive approach to efficiently allocating budgets towards multiple financial goals, it is not immune to problems that may arise over time. One such problem, specific to the field of computer software, is the possibility of evolving biases within the system. For example, as the system relies on historical data, user inputs, and algorithmic decision-making, it may inadvertently develop biases that impact the fairness and accuracy of budget allocations. These biases can manifest in various ways, such as favoring certain types of goals, overlooking the unique financial needs of specific user demographics, or being influenced by external factors that introduce unintended disparities. Over time, these biases may compromise the distribution of financial resources, potentially leading to suboptimal outcomes for users.

To address this problem and potentially enhance the fairness and reliability of the financial planning system, one embodiment of the present disclosure may employ a self-checking algorithm designed to periodically evaluate and adjust the system's operations. This self-checking algorithm may serve as a safeguard, ensuring the accuracy and integrity of the financial planning model. The algorithm may operate by periodically assessing the system's performance, particularly in the context of budget allocation and goal prioritization. It may scrutinize the results generated by the financial planning system, identifying any patterns of bias or inaccuracies in the allocation of funds towards various financial goals.

Upon detecting such discrepancies, the computer system may take proactive measures, such as initiating a recalibration process to enhance its own performance. This recalibration may involve fine-tuning parameters, optimizing training data, and implementing adjustments aimed at minimizing any biases that may have emerged. By continually monitoring and refining its own operations through this self-checking and recalibration approach, the financial planning system may ensure that it provides optimal results, addressing potential challenges associated with biases or inaccuracies that could affect the allocation of resources towards different financial objectives.

Finally, while several variations of the present disclosure have been illustrated by way of example in preferred or particular embodiments, it is apparent that further embodiments could be developed within the spirit and scope of the present disclosure, or the inventive concept thereof. However, it is to be expressly understood that such modifications and adaptations are within the spirit and scope of the present disclosure, and are inclusive, but not limited to the following appended claims as set forth.

What is claimed is:

1. A computer system for allocating a budget towards multiple financial goals, comprising:
a computing device comprising a memory and a processor, the memory storing instructions, and the processor operable to execute the instructions;
a user interface displayed on a monitor for facilitating user interaction with the computer system;
a user input device connected to the computing device for receiving inputs;
a first server comprising a database, the database storing a plurality of files and information for the computer system; and
wherein the processor is operable to perform a plurality of financial planning calculations.

2. The computer system of claim 1 wherein the processor is operable to display a savings budget on the user interface.

3. The computer system of claim 1 wherein the processor is operable to display a financial goal on the user interface.

4. The computer system of claim 1 wherein the processor is operable to display a spending need on the user interface.

5. The computer system of claim 1 wherein the processor is operable to display an account balance on the user interface.

6. The computer system of claim 1 further comprising a second server connected to the first server, the second server associated with a third-party application.

7. The computer system of claim 6 wherein at least one of the processor or the first server is operable to communicate with the second server through an application programming interface.

8. The computer system of claim 7 wherein the application programming interface is operable to send a request to the second server.

9. The computer system of claim 7 wherein the application programming interface is operable to send a response from the second server to the first server.

10. The computer system of claim 1 further comprising a plurality of electronic communication lines.

11. The computer system of claim 1 wherein the processor is operable to calculate a budget allocation for a financial goal and display the budget allocation on the user interface.

12. The computer system of claim 1 wherein the processor is operable to display a third-party application on the user interface.

13. The computer system of claim 1 wherein the processor is operable to perform the plurality of financial planning calculations based on a process.

14. The computer system of claim 13 wherein the process comprises deriving a budget allocation for a financial goal after receiving the inputs for a budget, a financial goal, and a spending need.

15. The computer system of claim 13 wherein the process comprises calculating a net goal funding for a fixed budget consumption.

16. The computer system of claim 13 wherein the process comprises considering an opportunity cost-adjusted or a risk-adjusted effectiveness when a planning alternative for a goal is repurposed for a different goal.

17. The computer system of claim 13 wherein the process comprises optimizing a plurality of budget allocations based on at least one of an investment risk, an inflation risk, a taxation liability, or a regulatory consequence.

18. The computer system of claim 13 wherein the process comprises allocating savings between at least one of a retirement goal, a health care spending, an insurance protection, or an emergency savings.

19. The computer system of claim 13 wherein the process comprises dictating an account type for holding savings.

20. The computer system of claim 13 wherein the process comprises allocating an existing savings toward a goal.
